(19) United States
(12) Patent Application Publication
(10) Pub. No.: US 2016/0340154 A1
(43) Pub. Date: Nov. 24, 2016

(54) ATTACHMENT FOR FORKLIFT

(71) Applicant: Caterpillar Inc., Peoria, IL (US)

(72) Inventor: Donald Glenn Samples, II, Spokane, WA (US)

(73) Assignee: Caterpillar Inc., Peoria, IL (US)

(21) Appl. No.: 15/230,255

(22) Filed: Aug. 5, 2016

(51) Int. Cl. B66C 9/10

(52) U.S. Cl. CPC B66C 9/10

(57) ABSTRACT

An attachment for a forklift is provided. The attachment includes a fork sleeve adapted to be coupled to a fork of the forklift. The attachment includes a frame extending from the fork sleeve. The attachment also includes a first arm having a first end and a second end. The first end is movably coupled to the frame. The first arm is distal with respect to the fork sleeve. The attachment further includes a second arm having a first end and a second end. The first end of the second arm is movably coupled to the first arm. The second end of the second arm is adapted to move at any location within a range of at least one of the first arm and the second arm.

### TECHNICAL FIELD

The present disclosure relates to an attachment for a forklift. More particularly, the present disclosure relates to the attachment for lifting material with the forklift.

### BACKGROUND

Machine such as a forklift is employed for transporting material from one location to another on a worksite. However, the forklift includes limited functionality for handling a bulk of the material to be transported such as by lifting and lowering. As a result, an additional tool may be employed on the worksite for added functionality during the transportation of the material.

For example, during transportation of a pallet having material stacked thereon, the forklift may lift the pallet from one location and lower the pallet at a desired location. However, for segregation of individual material from the pallet, another tool such as a hoist may be employed or may have to be done manually. This results in requirement of additional tooling such as the hoist leading to increased process cost.

Also, in many situations, a number of such hoists present within the worksite may be limited. As a result, the forklift may have to travel at the location of the hoist, which may be off a designated path, leading to increased travel time, increased cost, lowered handling efficiency, and so on.

Chinese Patent Number 203402895 describes a forklift having a hydraulic hoisting device. The hoisting device is provided on a tail portion of the forklift. The hoisting device is fixedly connected to a chassis of the forklift through a connecting support. The hoisting device includes multiple pairs of hydraulic telescopic landing legs arranged at a bottom of the forklift.

### SUMMARY OF THE DISCLOSURE

In an aspect of the present disclosure, an attachment for a forklift is provided. The attachment includes a fork sleeve adapted to be coupled to a fork of the forklift. The attachment includes a frame extending from the fork sleeve. The attachment also includes a first arm having a first end and a second end. The first end is movably coupled to the frame. The first arm is distal with respect to the fork sleeve. The attachment further includes a second arm having a first end and a second end. The first end of the second arm is movably coupled to the first arm. The second end of the second arm is adapted to move at any location within a range of at least one of the first arm and the second arm.

Other features and aspects of this disclosure will be apparent from the following description and the accompanying drawings.

### BRIEF DESCRIPTION OF THE DRAWINGS

FIG. 1 is a perspective view of an exemplary forklift and an attachment thereof in a disassembled position, according to a concept of the present disclosure;

FIG. 2 is a rear perspective view of the attachment of FIG. 1, according to the concept of the present disclosure; and

FIG. 3 is a perspective view of the forklift and the attachment thereof of FIG. 1 in an assembled position, according to the concept of the present disclosure.

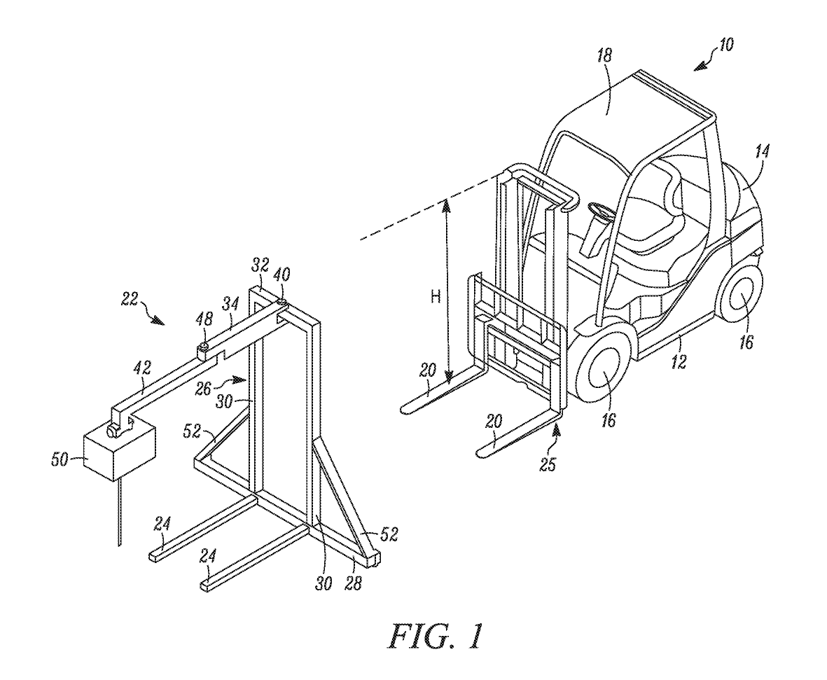

### DETAILED DESCRIPTION

Wherever possible, the same reference numbers will be used throughout the drawings to refer to the same or the like parts. Referring to FIG. 1, an exemplary forklift 10 is shown. The forklift 10 may also be generally known as a fork truck, a lift truck, a forklift truck, and so on. The forklift 10 is adapted to transport material from one location to another. The forklift 10 may be associated with an industry such as transportation, logistics, packaging, warehousing, material handling, and so on.

The forklift 10 includes a chassis 12. The chassis 12 supports one or more components of the forklift 10. The forklift 10 includes an enclosure 14 provided on the chassis 12. The enclosure 14 houses a power source (not shown). The power source may be any power source known in the art such as an internal combustion engine, a battery, a motor, and so on or a combination thereof. The forklift 10 includes a set of wheels 16 coupled to the chassis 12. The wheels 16 support and provide mobility to the forklift 10 on ground.

The forklift 10 includes an operator cabin 18 provided on the chassis 12. The operator cabin 18 includes various controls such as a steering, an operator console, an operator seat, levers, pedals, buttons, switches, knobs, and so on. The controls are adapted to control the forklift 10 on the ground. The forklift 10 also includes a fork 20 provided on the chassis 12. Additionally, the forklift 10 may include one or more hydraulic/pneumatic cylinders (not shown) coupled to the fork 20. The cylinders are adapted to translate the fork 20 in a vertical direction in order to lift and/or lower the material within a range of a height “H”.

The present disclosure relates to an attachment 22 for the forklift 10. The attachment 22 will now be explained in detail with reference to FIGS. 1, 2, and 3. The attachment 22 includes a fork sleeve 24. The fork sleeve 24 includes an elongated configuration similar to a configuration of the fork 20. The fork sleeve 24 couples the attachment 22 to the fork 20.

In the illustrated embodiment, the fork sleeve 24 includes a hollow configuration. Accordingly, the fork sleeve 24 slides over the fork 20 in order to couple the attachment 22 to the fork 20. More specifically, the fork 20 includes a wedge section 25 thereon. The wedge section 25 is adapted to be tapered fit within an opening 27 of the fork sleeve 24. In other embodiments, the fork sleeve 24 may be coupled to the fork 20 by any known methods of coupling such as bolting, clamping, and so on.

The attachment 22 includes a frame 26 extending from the fork sleeve 24. The frame 26 is disposed perpendicularly with respect to the fork sleeve 24. More specifically, the frame 26 includes abuse 28 coupled to the fork sleeve 24. The base 28 may be coupled to the fork sleeve 24 by any method known in the art such as bolting, riveting, welding, adhesion, and so on. The base 28 is adapted to couple the frame 26 to the fork sleeve 24. The frame 26 also includes a pair of vertical supports 30 extending perpendicularly from the base 28. Each of the pair of vertical supports 30 is parallel to one another. The pair of vertical supports 30 defines a height “H1” of the attachment 22. In other embodiments, the frame 26 may include a single or multiple vertical supports 30 extending from the base 28.

The frame 26 further includes a top support 32 coupled to the pair of vertical supports 30. The top support 32 is disposed distally with respect to the base 28. The top support 32 provides structural rigidity to the frame 26. In other embodiments where the frame 26 may include the single vertical support 30, the top support 32 may be omitted. The base 28, the pair of vertical supports 30, and the top support 32 define a rectangular configuration of the frame 26.

The attachment 22 includes a first arm 34 extending from the frame 26. The first arm 34 is movably coupled to the frame 26. The first arm 34 is disposed distally with respect to the fork sleeve 24. More specifically, the first arm 34 includes a first end 36 and a second end 38. In the illustrated embodiment, the first end 36 is rotatably coupled to the top support 32 via, a first joint 40. Accordingly, the first arm 34 rotates about the first axis X-X in a horizontal plane.

The attachment 22 includes a second arm 42 extending from the first arm 34. The second arm 42 is movably coupled to the first arm 34. More specifically, the second arm 42 includes a first end 44 and a second end 46. In the illustrated embodiment, the first end 44 of the second arm 42 is rotatably coupled to the second end 38 of the first arm 34 via a second joint 48. Accordingly, the second arm 42 rotates about a second axis Y-Y′ in a horizontal plane.

The second end 46 of the second arm 42 is adapted to move at any location within a range of at least one of the first arm 34 and the second arm 42. More specifically, the first joint 40 and the second joint 48 enable movement of the second end 46 of the second arm 42 in a space around the frame 26 within a locus of the first arm 34 and/or the second arm 42. It should be noted that in other embodiments, the attachment 22 may include only one arm or multiple arms in order to limit or improve a reach of the attachment 22 respectively without any limitation.

The attachment 22 further includes a hoist 50 coupled to the second end 46 of the second arm 42. The hoist 50 is adapted to raise and lower material based on application requirements. In other embodiments, the attachment 22 may include any other tool such as a hook, a pulley, an electromagnet, and so on based on application requirements.

It should be noted that a configuration of the frame 26, the first arm 34, and/or the second arm 42 described herein is merely and may vary based on application requirements. For example, in other embodiments, the first arm 34 may be slidably coupled to the top support 32 via the first joint 40. Accordingly, the first arm 34 may slide and/or rotate about the first joint 40 in the horizontal plane. Also, in other embodiments, the first end 44 of the second arm 42 may be slidably coupled to the second end 38 of the first arm 34 via the second joint 48. Accordingly, the second arm 42 may slide and/or rotate about the second joint 48 in the horizontal plane.

Additionally, the attachment 22 includes support arms 52 coupled to the frame 26. More specifically, the support arms 52 are disposed laterally with respect to the frame 26. The support arms 52 are coupled between the base 28 and the vertical supports 30 of the frame 26. The support arms 52 provide structural rigidity to the frame 26. It should be noted that number, arrangement, configuration and/or location of the support arms 52 on the frame 26 described herein is merely exemplary and may vary based on application requirements.

### INDUSTRIAL APPLICABILITY

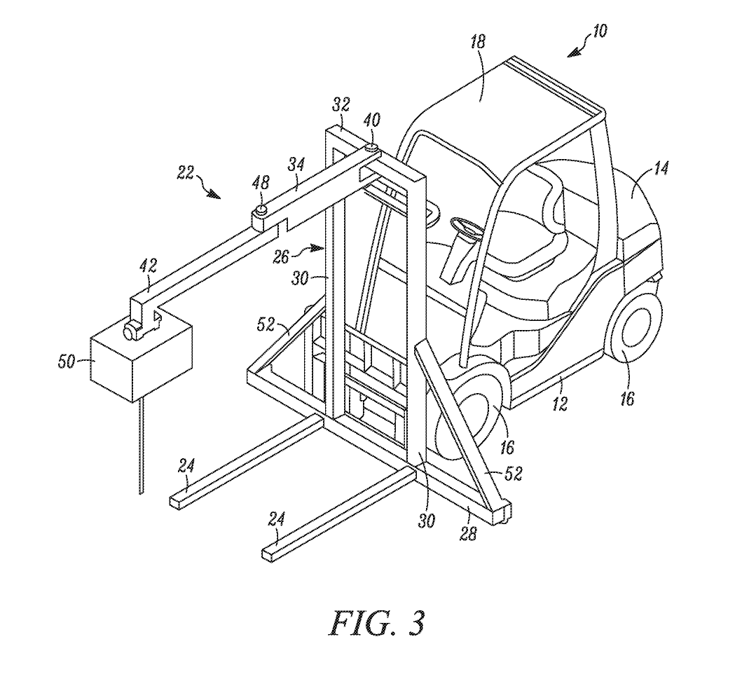

The present disclosure relates to the attachment 22 for the forklift 10. The attachment 22 provides additionally functionality of an additional tool such as the hoist 50 in addition to the fork 20 to the forklift 10. As shown in FIG. 3, the fork sleeve 24 may be employed as the fork 20 of the forklift 10 for lifting/lowering of the material. Additionally, the hoist 50 may provide handling of individual material by raising/lowering of the individual material. Also, the hoist 50 may provide increasing a lifting range of the forklift 10 by raising the material approximately up to the height “H1” of the frame 26 in addition to the translatory height “H” of the fork 20.

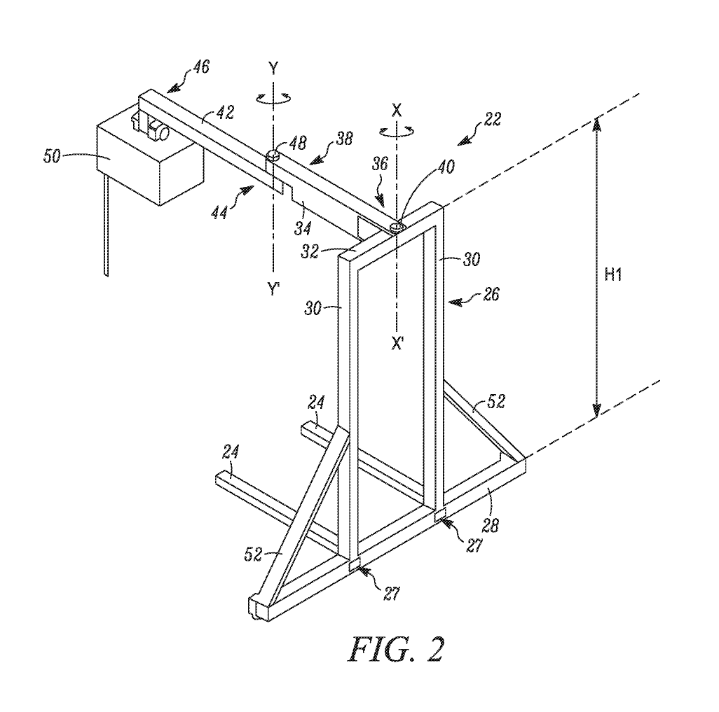

The attachment 22 provides a simple, efficient, and cost effective method of improving functionality/flexibility of the forklift 10 in addition to increasing an operating range thereof. The attachment 22 may be coupled/decoupled to the fork 20 of the forklift 10 by simply sliding the fork sleeve 24 over the fork 20, thus, limiting machine downtime required for mounting of the attachment 22. Also, in some situations, as shown in FIG. 2, the attachment 22 may be used as a standalone tool without mounting on the forklift 10 for raising/lowering of the material.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An attachment for a forklift, the attachment comprising:
a fork sleeve adapted to be coupled to a fork of the forklift;
a frame extending from the fork sleeve;
a first arm having a first end and a second end, the first end movably coupled to the frame, the first arm being distal with respect to the fork sleeve; and
a second arm having a first end and a second end, the first end of the second arm movably coupled to the first arm,
wherein the second end of the second arm is adapted to move at any location within a range of at least one of the first arm and the second arm.

2. The attachment of claim 1, wherein the first arm and the second arm move in a horizontal plane.

3. The attachment of claim 1, wherein the fork sleeve includes a hollow configuration.

4. The attachment of claim 1, wherein the frame is disposed perpendicularly with respect to the fork sleeve.

5. The attachment of claim 1 further includes a hoist coupled to the second end of the second arm.

6. The attachment of claim 1 includes a plurality of support arms disposed laterally with respect to the frame.
